(19) United States
(12) Patent Application Publication
(10) Pub. No.: US 2003/0225658 A1
(43) Pub. Date: Dec. 4, 2003

(54) Buy-write indexes

(75) Inventor: Robert E. Whaley, Chapel Hill, NC (US)

Correspondence Address: FOLEY & LARDNER, 321 NORTH CLARK STREET, SUITE 2800, CHICAGO, IL, 60610-4764, US

(73) Assignee: Chicago Board Options Exchange

(21) Appl. No.: 10/340,035

(22) Filed: Jan. 10, 2003

Related U.S. Application Data
(60) Provisional application No. 60/385,410, filed on Jun. 3, 2002.

(51) Int. Cl. G06F 17/60

(52) U.S. Cl. 705/36

(57) ABSTRACT

A financial instrument in accordance with the principles of the present invention provides a passive total return index based on writing the nearby call option against that same underlying asset portfolio for a set period on the day the previous nearby call option contract expires. The call written will have that set period remaining to expiration, with an exercise price just above the prevailing underlying asset price level (i.e., slightly out of the money). The call option is held until expiration and cash settled, at which time a new call option is written for the set period.

### CROSS-REFERENCE TO RELATED PATENT APPLICATIONS

This application is a Non-Provisional of U.S. Application No. 60/385,410, filed Jun. 3, 2002, incorporated herein by reference in its entirety.

### FIELD OF THE INVENTION

The present invention relates to buy-write indexes.

### BACKGROUND OF THE INVENTION

Hedging can be defined as the purchase or sale of a security or derivative (such as options or futures and the like) in order to reduce or neutralize all or some portion of the risk of holding another security or other underlying asset. Hedging equities is an investment approach that can alter the payoff profile of an equity investment through the purchase and/or sale of options or other derivatives. Hedged equities are usually structured in ways that mitigate the downside risk of an equity position, albeit at the cost of some of the upside potential. A buy-write hedging strategy generally is considered to be an investment strategy in which an investor buys a stock or a basket of stocks, and simultaneously sells or “writes” covered call options that correspond to the stock or basket of stocks. An option can be defined as a contract between two parties in which one party has the right but not the obligation to do something, usually to buy or sell some underlying asset at a given price, called the exercise price, on or before some given date. Options have been traded on the SEC-regulated Chicago Board Options Exchange since 1973. Call options are contracts giving the option holder the right to buy something, while put options, conversely entitle the holder to sell something. A covered call option is a call option that is written against the appropriate opposing position in the underlying security (such as, for example, a stock or a basket of stocks and the like) or other asset (such as, for example, an exchange traded fund or future and the like).

Buy-Write strategies provide option premium income that can help cushion downside moves in an equity portfolio; thus, some Buy-Write strategies significantly outperform stocks when stock prices fell. Buy-Write strategies have an added attraction to some investors in that Buy-Writes can help lessen the overall volatility in many portfolios.

One past drawback of utilizing a buy-write strategy is that no suitable benchmark index has existed against which a particular portfolio manager's performance could be measured. Even those who understand the buy-write strategy may not have the resources to see how well a particular implementation of the strategy has performed in the past. While buy-write indexes have been proposed in the prior art, these have not satisfied the market demand for such indexes. For example, Schneeweis and Spurgin, “The Benefits of Index Option-Based Strategies for Institutional Portfolios,” The Journal of Alternative Investments, Spring 2001, pp. 44-52, stated that “the returns for these passive option-based strategies provide useful benchmarks for the performance of the active managers studies”, thus recognizing the industry need for a buy-right index. Schneeweis and Spurgin proposed “a number of passive benchmarks” constructed “by assuming a new equity index option is written at the close of trading each day.” The option was priced by using “implied volatility quotes from a major broker-dealer.” Two strategies were employed. A “short-dated” strategy used options that expire at the end of the next day's trading. A “long-dated strategy” involved selling (buying) a 30-day option each day and then buying (selling) the option the next day. The study noted that “these indexes are not based on observed options prices . . . As such, these indexes are not directly investible.” In light of the fact that the proposed indexes in the study are not directly investible and have not been updated, the indexes utilized in this study have not gained acceptance.

A key attribute to the success of any index is its perceived integrity. Integrity, in turn, is based on a sense of fairness. For the market to perceive an index to be a “fair” benchmark of performance, the rules governing index construction must be objective and transparent. Also, it would be advantageous for the index to strike an appropriate balance between the transaction costs for unduly short-term options and the lack of premiums received from unduly long-term options. Also, it would be advantageous for the index to represent an executable trading strategy as opposed to a theoretical measure. Still further, it would be advantageous for the index to be updated and disseminated on a daily basis.

What is thus needed is index that provides the investment community with a benchmark for measuring option over-writing performance. Such index should provide the performance of a simple, investible option overwriting trading strategy. Such index must be objective and transparent.

### SUMMARY OF THE INVENTION

An index in accordance with the principles of the present invention provides the investment community with a benchmark for measuring option buy-write performance. An index in accordance with the principles of the present invention provides the performance of a simple, investible option buy-write trading strategy. An index in accordance with the principles of the present invention is objective and transparent.

An index in accordance with the principles of the present invention provides a passive total return index based on writing a nearby call option (such as, for example, a stock or stock index call option and the like) against a portfolio of that same underlying asset (such as, for example, a stock or a basket of stocks and the like) for a set period on the day the previous nearby call option contract expires. The call written will have that set period remaining to expiration, with an exercise price just above the prevailing underlying asset price level (for example, slightly out of the money). The call is held until expiration and cash settled, at which time a new call option is written for the set period.

### BRIEF DESCRIPTION OF THE DRAWINGS

FIG. 1 sets forth the month-end total return indexes for the S&P 500® and an example index in accordance with the principles of the present invention for the period from June 1988 through December 2001.

FIG. 2 sets forth the standardized monthly returns of the S&P 500® and an example index in accordance with the principles of the present invention for the period June 1988 through December 2001.

FIG. 3 sets forth the average implied and realized volatility for the S&P 500® index options in each year 1988 through 2001.

### DETAILED DESCRIPTION OF THE PREFERRED EMBODIMENTS

In accordance with the principles of the present invention, a financial instrument is created by writing a nearby, just out-of-the-money call option against the underlying asset portfolio. The call option is written in a given time period on the day the previous nearby call option contract expires. The premium collected from the sale of the call is added to the total value of the financial instrument's total value.

In one embodiment in accordance with the principles of the present invention, a financial instrument was designed to reflect on a portfolio that invests in the stocks in an index that also sells covered call options on that stock index. Such a financial instrument is a passive total return financial instrument based on writing a nearby, just out-of-the-money call option against the stock index portfolio for a given period of time, such as for example, monthly or quarterly. The call written will have approximately the same given period of time remaining to expiration, with an exercise price just above the prevailing index level. In a preferred embodiment, the call is held until expiration and cash settled, at which time a new nearby, just out-of-the-money call is written for that same given period of time. The premium collected from the sale of the call is added to the total value of the financial instrument.

In one embodiment in accordance with the principles of the present invention, an index was designed to reflect on a portfolio that invests in Standard & Poor's® 500 Index stocks that also sells S&P 500® index covered call options (ticker symbol “SPX”). The S&P 500® index is disseminated by Standard & Poor's, 55 Water Street, New York, N.Y. 10041 (“S&P”). S&P 500® index options are offered by the Chicago Board Options Exchange®, 400 South LaSalle Street, Chicago, Ill. 60605 (“CBOE®”). In an alternative embodiment, an index could be designed to reflect on a portfolio that invests in Dow Jones Industrials Index stocks that also sells Dow Jones Industrials index covered call options (DJX). The Dow Jones Industrials index is disseminated by Dow Jones & Company Dow Jones Indexes, P.O. Box 300, Princeton, N.J. 08543-0300. Dow Jones Industrials index options are offered by the Chicago Board Options Exchange®, 400 South LaSalle Street, Chicago, Ill. 60605 (“CBOE®”). In further alternative embodiments, indexes could be designed to reflect on a portfolio that invests in NASDAQ-100 (NDX) stocks or any other equity index that also sells NASDAQ or any other equity index covered call options.

In a further alternative embodiment in accordance with the principles of the present invention, an exchange traded fund could be designed to reflect on a portfolio that invests in Standard & Poor's® 500 Index stocks that also sells S&P 500® index covered call options (SPX). In a still further alternative embodiment, an exchange traded fund could be designed to reflect on a portfolio that invests in Dow Jones Industrials Index stocks that also sells Dow Jones Industrials index covered call options (DJX).

Still further alternative embodiments within the scope of the principles of the present invention could entail mutual funds or other structured products. For example, in another embodiment in accordance with the principles of the present invention, a portfolio with a protective put option can be used. A protective put option position is comprised of a long stock or stock basket position and a corresponding long put option position designed to protect the stock or stock basket position. In another embodiment in accordance with the principles of the present invention, a portfolio with a protective “collar” position can be used. A protective collar position is comprised of a long stock or stock basket position, a corresponding long put option position designed to protect the stock or stock basket position, and a corresponding short call position designed to generate income.

### EXAMPLE

As previously referenced, in one embodiment in accordance with the principles of the present invention, an index was designed to reflect on a portfolio that invests in Standard & Poor's® 500 Index stocks that also sells S&P 500® index covered call options (SPX). The S&P 500® index is disseminated by Standard & Poor's, 55 Water Street, New York, N.Y. 10041 (“S&P”). S&P 500® index options are offered by the Chicago Board Options Exchange®, 400 South LaSalle Street, Chicago, Ill. 60605 (“CBOE®”). Such an index is a passive total return index based on writing a nearby, just out-of-the-money S&P 500® (SPX) call option against the S&P 500® stock index portfolio each month—usually at 10:00 a.m. Central Time on the third Friday of the month. The SPX call written will have approximately one month remaining to expiration, with an exercise price just above the prevailing index level. In a preferred embodiment, the SPX call is held until expiration and cash settled, at which time a new one-month, nearby, just out-of-the-money SPX call is written. The premium collected from the sale of the call is added to the index's total value.

To understand the construction of the example index, the S&P 500® index return series is considered. The S&P 500® index return series makes the assumption that any daily cash dividends paid on the index are immediately invested in more shares of the index portfolio. (Standard & Poor's makes the same assumption in its computation of the total annualized return for the S&P 500® index.) The daily return of the S&P 500® index portfolio is therefore computed as:

$${R}_{St} = \frac{{S}_{1} - {S}_{t - 1} + {D}_{1}}{{S}_{t - 1}}$$

where S₁ is the reported S&P 500® index level at the close of day t, and Dt is the cash dividend paid on day t. The numerator contains the income over the day, which comes in the form of price appreciation, S₁-Sₜ₋₁, and dividend income, Dₜ. The denominator is the investment outlay, that is, the level of the index as of the previous day's close, Sₜ₋₁.

The return of an index constructed in accordance with the principles of the present invention is the return on a portfolio that consists of a long position in an equity (for example, stock) index and a short position in a call option for that equity index. In the example embodiment, the return on the index consists of a long position in the S&P 500® index and a short position in an S&P 500® call option. The daily return of an index constructed in accordance with the principles of the present invention is defined as:

$${R}_{BXM1} = \frac{{S}_{1} + {D}_{1} - {S}_{t - 1} - ( {C}_{1} - {C}_{t - 1} )}{{S}_{t - 1} {C}_{t - 1}}$$

where Cₜ is the reported call price at the close of day t and all other notation is as previous defined. The numerator in this expression contains the price appreciation and dividend income of the index less the price appreciation of the call, Cₜ-Cₜ₋₁. The income on the index exceeds the equity index on days when the call price falls, and vice versa. The investment cost in the denominator of this expression is the S&P 500® index level less the call price at the close on the previous day.

The example index constructed in accordance with the principles of the present invention was compared to the historical return series beginning June 1, 1988, the first day that Standard and Poor's began reporting the daily cash dividends for the S&P 500® index portfolio, and extending through Dec. 31, 2001. The daily prices/dividends used in the return computations were taken from the following sources. First, the S&P 500® closing index levels and cash dividends were taken from monthly issues of Standard & Poor's S&P 500® Index Focus Monthly Review available from Standard & Poor's, 55 Water Street, New York, N.Y. 10041. Second, the daily S&P 500® index option prices were drawn from the CBOE®'s market data retrieval (MDR) data file, the Chicago Board Options Exchange®, 400 South LaSalle Street, Chicago, Ill. 60605.

Three types of call prices are used in the construction of the example index. The bid price is used when the call is first written, the settlement price is used when the call expires, and the bid/ask midpoint is used at all other times. The bid price is used when the call is written to account for the fact that a market order to sell the call would likely be consummated at the bid price. In this sense, the example index already incorporates an implicit trading cost equal to one-half the bid/ask spread.

In generating the history of example index returns, calls were written and settled under two different S&P 500® option settlement regimes. Prior to October 16, 1992, the “PM-settlement” S&P 5000 calls were the most actively traded, so they were used in the construction of the history of the example index. The newly written call was assumed to be sold at the prevailing bid price at 3:00 p.m. (Central Standard Time), when the settlement price of the S&P 500® index was being determined. The expiring call's settlement price was:

C_{settle,t}=max(0, S_{settle,t}−X)

where S_{settle,t} is the settlement price of the call, and X is the exercise price. Where the exercise price exceeds the settlement index level, the call expires worthless.

After Oct. 16, 1992, the “AM-settlement” contracts were the most actively traded and were used in the construction of the history of the example index. The expiring call option was settled at the open on the day before expiration using the opening S&P 500® settlement price. A new call with an exercise price just above the S&P 500® index level was written at the prevailing bid price at 10:00 a.m. (Central Standard Time). Other than when the call was written or settled, daily returns were based on the midpoint of the last pair of bid/ask quotes appearing before or at 3:00 p.m. (Central Standard Time) each day, that is:

$${C}_{3 PM , t} \frac{{bidprice}_{3 PM} + {askprice}_{3 PM}}{2}$$

Based on these price definitions and available price and dividend data, a history of daily returns was computed for the example index for the period June 1988 through December 2001. On all days except expiration days as well as expiration days prior to Oct. 16, 1992, the daily return was computed using the daily return formula previously set forth, that is:

$${R}_{BXM1} = \frac{{S}_{1} + {D}_{1} - {S}_{t - 1} - ( {C}_{1} - {C}_{t - 1} )}{{S}_{t - 1} {C}_{t - 1}}$$

On expiration days since Oct. 16, 1992, the daily return is computed using:

R_{BXM,t}=(1+R_{ON,t})X(1+R_{ID,t})−1

where R_{ON,t} is the overnight return of the buy-write strategy based on the expiring option, and R_{ID,t} is the intra-day buy-write return based on the newly written call. The overnight return is computed as:

$${R}_{ON , t} = \frac{{S}_{10 AM , t} + {D}_{1} - {S}_{close , t - 1} - ( {C}_{settle , t} - {C}_{close , t - 1} )}{{S}_{close , t - 1} - {C}_{close , t - 1}}$$

where S_{10AM,t} is the reported level of the S&P 500® index at 10:00 a.m. on expiration day, C_{settle,t} is the settlement price of the expiring option. The settlement price is based on the special opening S&P 500® index level computed on expiration days and used for the settlement of S&P 500® index options and futures. Note that the daily case dividend, Dₜ, is assumed to be paid overnight. The intra-day return is defined as:

$${R}_{1 D , t} = \frac{{S}_{close , t} - {S}_{10 AM , t} - ( {C}_{close , t} - {C}_{10 AM , t} )}{{S}_{10 AM , t} - {C}_{10 AM , t}}$$

where the call prices are for the newly written option. The exercise price of the call is the nearby, just out-of-the-money option based on the reported 10:00 a.m. S&P 500® index level.

Next, the properties of the realized monthly returns of the example index in accordance with the principles of the present invention are examined. Table 1 below contains summary statistics for the realized monthly returns of a one-month money market instrument, the S&P 500® index portfolio, and the example index portfolio. The monthly returns were generated by linking daily returns geometrically, that is:

$${R}_{monthly} = {\prod }_{t = 1}^{{inmonth}^{no , ofdays}} ( 1 + {R}_{daily , t} ) - 1$$

The money market rate is assumed to be the rate of return of a Eurodollar time deposit whose number of days to maturity matches the number of days in the month. The Eurodollar rates were downloaded from Datastream, available from Thomson Financial, 195 Broadway, New York, N.Y. 10007.

Table 1 sets forth summary statistics for monthly returns of money market deposits, the S&P 500® index portfolio, and the example index during the period June 1988 through December 2001, where BXM represents the example index in accordance with the principles of the present invention. Table 1 shows that the average monthly return of the one-month money market instruments over the 163-month period was 0.483%. Over the same period, the S&P 500® index portfolio generated an average monthly return of 1.187%, while the example index generated an average monthly return of 1.106%. Although the monthly average monthly return of the example index was only 8.1 basis points lower than the S&P 500®, the risk of the example index, as measured by the standard deviation of return, was substantially lower. For the example index, the standard deviation of monthly returns was 2.663%, while, for the S&P 500®, the standard deviation was 4.103%. In other words, the example index surprisingly produced a monthly return approximately equal to the S&P 500® index portfolio, but at less than 65% of the S&P 500®'s risk (i.e., 2.663% vs. 4.103%), where risk is measured in the usual way.

TABLE 1

| | | | | Al- |
|---|---|---|---|---|
| | | | | ternative |
| | | | | Buy-write |
| | Money | S&P 500 ® | BXM | Using |
| Statistic | Market | Portfolio | Portfolio | Midpoints |
| Monthly Returns | 163 | 163 | 163 | 163 |
| Mean | 0.483% | 1.187% | 1.106% | 1.159% |
| Median | 0.467% | 1.475% | 1.417% | 1.456% |
| Standard Deviation | 0.152% | 4.103% | 2.663% | 2.661% |
| Skewness | 0.4677 | −0.4447 | −1.4366 | −1.4055 |
| Excess Kurtosis | −0.2036 | 0.7177 | 4.9836 | 4.8704 |
| Jarque-Bera Test | 6.22 | 8.87 | 224.75 | 214.77 |
| Statistic | | | | |
| Probability of Normal | 0.045 | 0.012 | 0.000 | 0.000 |
| Annual Returns | | | | |
| Mean | 5.95% | 14.07% | 13.63% | 14.34% |

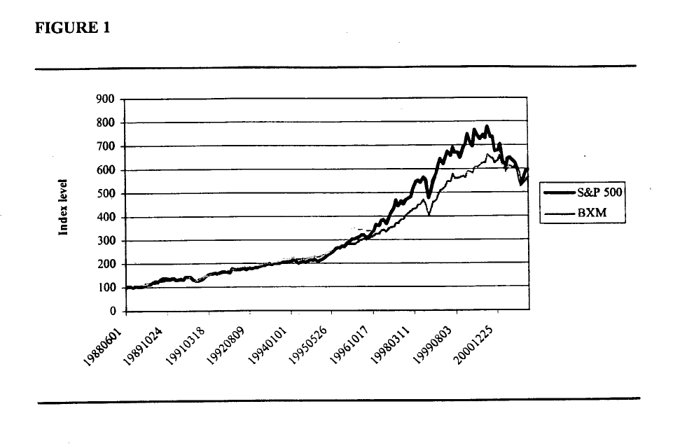

The return and risk of the example index portfolio relative to the S&P 500® index portfolio also can be seen in FIG. 1. FIG. 1 sets forth the month-end total return indexes for the S&P 500® and the example index for the period from June 1988 through December 2001. In generating the history of the example index levels, the index was set equal to 100 on June 1, 1988. The closing index level for each subsequent day was computed using the daily index return, that is:

BXMₜ=(BXMₜ₋₁)×(1+R_{BXM,t})

where BXM represents the example index. To facilitate comparing the example index with the S&P 500® index over the same period, the total return index of the S&P 500® index portfolio also was normalized to a level of 100 on June 1, 1988 and plotted in FIG. 1. As FIG. 1 shows, the example index tracked the S&P 500® index closely at the outset. Then, starting in 1992, the example index began to rise faster than the S&P 500®, but, by mid-1995, the level of the S&P 500® total return index surpassed the example index. Beginning in 1997, the S&P 500® index charged upward in a fast but volatile fashion. The example index lagged behind, as should be expected. When the market reversed in mid-2000, the example index again moved ahead of the S&P 500®. The steadier path taken by the example index reflects the fact that it has lower risk than the S&P 500®. That both indexes wind up at approximately the same level after 13½ years reflects the fact that both had similar returns.

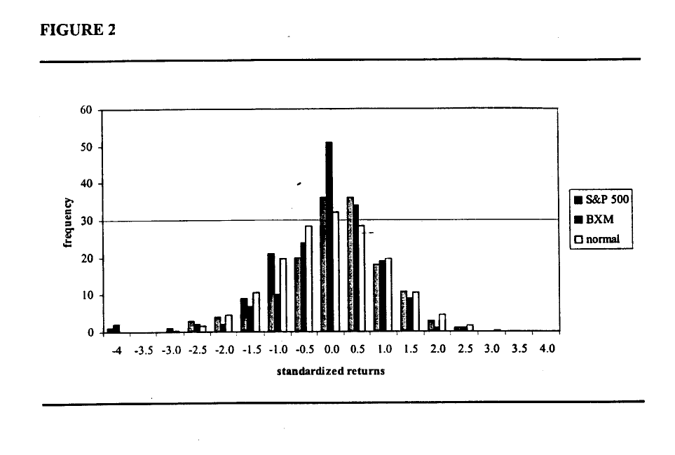

Table 1 also reports the skewness and excess kurtosis of the monthly return distributions as well as the Jarque-Bera statistic for testing the hypothesis that the return distribution is normal. Both the S&P 500® portfolio and the example index have negative skewness. For the example index, negative skewness should not be surprising in the sense that a buy-write strategy truncates the upper end of the index return distribution. But, the Jarque-Bera statistic rejects the hypothesis that returns are normal, not only for the example index and S&P 500®, but also for the money market rates. The negative skewness for the example index and S&P 500® does not appear to be severe, however. FIG. 2 sets forth the standardized monthly returns of the S&P 500® and example index in relation to the normal distribution for the period June 1988 through December 2001. The S&P 500® and example index return distributions appear more negatively skewed than the normal, but only slightly. What stands out in FIG. 2 is that both the S&P 500® and the example index return distributions have greater kurtosis than the normal distribution. This is reassuring in the sense that the usual measures of portfolio performance work well for symmetric distributions but not asymmetric ones.

Finally, to illustrate the degree to which writing the calls at the bid price rather than the bid/ask midpoint affected returns, the example index was re-generated assuming that the calls were written at the bid/ask price midpoint. As Table 1 shows, the average monthly return increased by about 6 basis points per month. The difference in annualized returns is about 70 basis points.

Next, the performance of the example index in accordance with the principles of the present invention is examined. The most commonly-applied measures of portfolio performance are the Sharpe ratio:

$$Sharpe ratio = \frac{{\overline{R}}_{p} - {\overline{R}}_{f}}{\hat{σ}}$$

(Sharpe, William F., Mutual Fund Performance, Journal of Business 39 (1), 119-138 (1966)); the Treynor ratio:

$$Treynor Ratio = \frac{{\overline{R}}_{p} - {\overline{R}}_{f}}{\hat{{β}_{p}}}$$

(Treynor, Jack L., How to Rate Management of Investment Funds, Harvard Business Review 43 (1), 63-75 (1965)); Modigliani and Modigliani's M-squared:

$$M \text{-} squared = ( {\overline{R}}_{p} - {\overline{R}}_{f} ) ( \frac{{\hat{σ}}_{m}}{{\hat{σ}}_{s}} ) - ( {\overline{R}}_{m} - {\overline{R}}_{f} )$$

(Modigliani, Franco and Modigliani, Leah, Risk-Adjusted Performance, Journal of Portfolio Management (Winter), 45-54); and Jensen's alpha:

Jensen's alpha=\overline{R}ₚ−\overline{R}_{f}−\hat{β}ₚ(\overline{R}ₘ−\overline{R}_{f})

(Jensen, Michael C., The Performance of Mutual Funds in the Period 1945-1964, Journal of Finance 23 (May). 389-416). All four measure are based on the Sharpe/Lintner mean/variance capital asset pricing model (Sharpe, William F., 1964, Capital Asset Prices: A Theory of Market Equilibrium under Conditions of Risk, Journal of Finance 19, 425-442; Lintner, John, The Valuation of Risk Assets and the Selection of Risky Investments in Stock Portfolios and Capital Budgets, Review of Economics and Statistics 47, 13-37 (1969)). In the mean/variance capital asset pricing model, investors measure total portfolio risk by the standard deviation of returns.

In assessing ex-post performance, the parameters of the formulas are estimated from historical returns over the evaluation period. First, \overline{R}_{f}, \overline{R}ₘ \overline{R}ₚ are the mean monthly returns of a “risk-free” money market instrument, the market, and the portfolio under consideration over the evaluation period. Second, \hat{σ}ₘ and \overline{σ}ₚ are the standard deviations of the returns (“total risk”) of the market and the portfolio. Finally, \hat{β}ₚ is the portfolio's systematic risk (“beta”) estimated by an ordinary least squares, time-series regression of the excess returns of the portfolio on the excess returns of the market, that is:

R_{p,t}−R_{f,t}=αₚ(R_{m,t}−R_{f,t})+ε_{p,t}

In addition, the risk of the example index in accordance with the principles of the present invention can be measured using Markowitz's semi-variance or semi-standard deviation as a total risk measure. (Markowitz, Harry, Portfolio Selection, Chapter 9 (New York: John Wiley and Sons 1959)). In the context of performance measurement, semi-standard deviation can be defined as the square root of the average of the squared deviations from the risk-free rate of interest, where positive deviations are set equal to zero, that is:

$$Total {risk}_{i} + \sqrt{{\sum }_{t = 1}^{r} {min ( {R}_{i , t} - {R}_{f , t} , 0 )}^{2}} / T$$

where i=m, p. Returns on risky assets, when they exceed the risk-free rate of interest, do not affect risk. To account for possible asymmetry of the portfolio return distribution, the total risk portfolio performance measures (a) and (b) in Table 2 is recomputed using the estimated semi-deviations of the returns of the market and the portfolio are inserted for \hat{σ}ₘ and \hat{σ}ₚ.

The systematic risk based portfolio performance measures also have theoretical counterparts in a semi-variance framework. The only difference lies in the estimate of systematic risk. To estimate the beta, a time-series regression through the origin is performed using the excess return series of the market and the portfolio. Where excess returns are positive, they are replaced with a zero value. The time-series regression specification is:

min(R_{p,t}−R_{f,t}, 0)=βₚmin(R_{m,t}−R_{f,t}, 0)+ε_{p,t}

The performance of the example index in accordance with the principles of the present invention is evaluated using the measures described above, where risk is measured using the standard deviation and the semi-standard deviation of portfolio returns. To the extent that example index returns are skewed, the measures derived from the two different models will differ. Since the standardized example index return distribution show slight negative skewness, the performance measures based on semi-standard deviation should be less than their standard deviation counterparts, but not by much. Table 2 sets forth the estimated performance measures based on monthly returns of the S&P 500® index portfolio and the example index during the period June 1988 through December 2001, where BXM represents the example index.

TABLE 2

| | | | | | | Alternative |
|---|---|---|---|---|---|---|
| | | | S&P 500 | BXM | BMX | Buy-write Using |
| | | Total Risk | Portfolio | Portfolio | Portfolio | Theoretical Values |
| Performance Measure | Total Risk Measure | Measure | Risk | Performance | Risk | Performance |
| Total Risk Based | | | | | | |
| Sharpe Ratio | Standard Deviation | 0.172 | 0.04103 | 0.234 | 0.02663 | 0.181 |
| | Semi-Standard Deviation | 0.261 | 0.02696 | 0.331 | 0.01886 | 0.255 |
| M-Squared | Standard Deviation | | | 0.257% | | 0.040% |
| | Semi-Standard Deviation | | | 0.188% | | −0.017% |
| Systematic Risk Based | | | | | | |
| Treynor Ratio | Standard Deviation | 0.007 | 1.000 | 0.011 | 0.558 | 0.009 |
| | Semi-Standard Deviation | 0.007 | 1.000 | 0.010 | 0.622 | 0.008 |
| Jensen Alpha | Standard Deviation | | | 0.0230% | 0.558 | 0.095% |
| | Semi-Standard Deviation | | | 0.0186% | 0.622 | 0.045% |

The results of Table 2 shows the example index outperformed the S&P 500® index on a risk-adjusted basis over the investigation period. All estimated performance measures, independent of whether they are based on the mean/standard deviation or mean/semi-standard deviation frameworks, lead to this conclusion. The out-performance appears to be on order of 0.2% per month on a risk-adjusted basis. The performance results were also computed using the Bawa-Lindenberg and Leland capital asset pricing models which allow for asymmetrical return distributions. (Bawa, Vijay S. and Lindenberg, Eric B., Capital Market Equilibrium in a Mean-Lower Partial Moment Framework, Journal of Financial Economics 5, 189-200 (1977); Leland, Hayne E., 1999, Beyond Mean-Variance: Performance Measurement in a Nonsymmetrical World, Financial Analysts Journal (January/February), 27-36 (1999)). The performance results were similar to those of the mean/semi-standard deviation framework.

Second, the estimated performance measures using mean/semi-standard deviation are slightly lower than their counterparts using mean/standard deviation. The cause is the negative skewness in example index returns that was displayed in Table 1 and FIG. 2. The effect of skewness is impounded through the risk measure. In Jensen's alpha, for example, the “beta” of the example index is 0.558 using the mean/standard framework and 0.622 using the mean/semi-standard deviation framework. The skewness “penalty” is about 5 basis points per month.

In an efficiently functioning capital market, the risk-adjusted return of a buy-write strategy using S&P 500® index options should be no different than the S&P 500® portfolio. Yet, the example index has provided a surprisingly high return relative to the S&P 500® index portfolio over the period June 1988 through December 2001. One possible explanation for this surprisingly high return is that the volatilities implied by option prices are too high relative to realized volatility. (See, for example, Stux, Ivan E. and Fanelli, Peter R., Hedged Equities as an Asset Class, Morgan Stanley Equities Analytical Research (1990); Schneeweis, Thomas and Spurgin, Richard, The Benefits of Index Option-Based Strategies for Institutional Portfolios, Journal of Alternative Investments (Spring), 44-52. (2001)). In this possible explanation, there is excess buying pressure on S&P 500® index puts by portfolio insurers. (See Bollen, Nicolas P. B. and Whaley, Robert E., Does Price Pressure Affect the Shape of Implied Volatility Functions? Duke University (2002)). Since there are no natural counter parties to these trades, market makers must step in to absorb the imbalance. As the market maker's inventory becomes large, implied volatility will rise relative to actual return volatility, with the difference being the market maker's compensation for hedging costs and/or exposure to volatility risk. The implied volatilities of the corresponding calls also rise from the reverse conversion arbitrage supporting put-call parity.

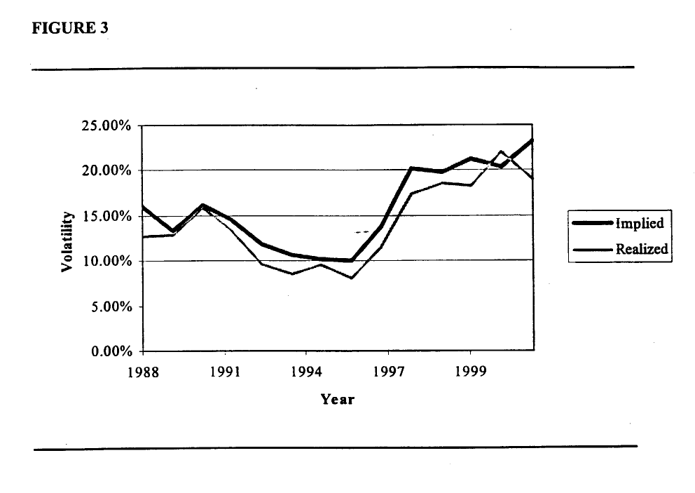

To examine whether this explanation is consistent with the observed performance of the example index, the average implied volatility of the calls written in the example index strategy were compared to the average realized volatility over the life of the call. The implied volatility was computed by setting the observed call price equal to the Black-Scholes/Merton formula value (set forth below). (Black, Fischer and Scholes, Myron, The Pricing of Options and Corporate Liabilities, Journal of Political Economy 81, 637-659 (1973); Merton, Robert C., 1973, Theory of Rational Option Pricing, Bell Journal of Economics and Management Science, 141-183 (1973). FIG. 3 sets forth the average implied and realized volatility for the S&P 500® index options in each year 1988 through 2001. FIG. 3 shows that the difference has not been constant through time, perhaps indicating variation in the demand for portfolio insurance. The difference is persistently positive, however, with the mean (median) difference between the at-the-money (ATM) call implied volatility and realized volatility being about 167 (234) basis points on average.

To show that the high levels of implied volatility for S&P 500® index options were at least partially responsible for generating the abnormal returns of the example index, the buy-write index was reconstructed, this time using theoretical option values rather than observed option prices. The theoretical call value was generated using the Black-Scholes)/Merton formula:

c=(S−PVD)N(d₁)−X e^{-rT} N(d₂)

where

$${d}_{1} = \frac{In ( ( S - PVD ) / X ) + ( r + 5 {σ}^{2} ) T}{σ \sqrt{T}} , {d}_{2} = {d}_{1} - σ \sqrt{T} ,$$

S is the prevailing index level, PVD is the present value of the dividends paid during the option's life, X is the exercise price of the call, r is the Eurodollar rate with a time to expiration matching the option, and σ is the realized volatility computed using the daily returns of the S&P 500® index over the option's one-month remaining life. The column labeled “Alternative Buy-Write Using Theoretical Values” in Table 2 contains the performance results. Although all performance measures are positive, they are all small, particularly for the theoretically superior semi-variance measures. The highest semi-variance measure is the Jensen alpha at 0.045%. Based upon the reduction in performance when theoretical values are used in place of actual prices, at least some of the risk-adjusted performance of the example index appears to arise from portfolio insurance demands.

Table 3 provides estimates of implied and realized volatility for S&P 500 (SPX) options. The example index in accordance with the present invention was able to achieve good relative risk-adjusted returns over the 1989-2001 time period in part because implied volatility often was higher than realized volatility, and sellers of SPX options were rewarded because of

TABLE 3

| | Implied Volatility | Realized Volatility |
|---|---|---|
| 1989 | 0.13 | 0.12 |
| 1990 | 0.16 | 0.15 |
| 1991 | 0.15 | 0.14 |
| 1992 | 0.12 | 0.10 |
| 1993 | 0.11 | 0.09 |
| 1994 | 0.10 | 0.10 |
| 1995 | 0.10 | 0.08 |
| 1996 | 0.13 | 0.12 |
| 1997 | 0.19 | 0.17 |
| 1998 | 0.20 | 0.19 |
| 1999 | 0.22 | 0.18 |
| 2000 | 0.20 | 0.21 |
| 2001 | 0.24 | 0.21 |
| Average | 0.16 | 0.14 |

Table 4 provides year-end prices for the example index in accordance present invention and various stock price indexes from 1988 through 2001.

TABLE 4

| | | | | | | Dow |
|---|---|---|---|---|---|---|
| | | S&P | | | | Jones |
| | Exam- | 500 | | | | Indus- |
| | ple | Total | S&P | S&P | Nasdaq | trial |
| | Index | Return | 500 | 100 | 100 | Avg. |
| | BXM | SPTR | SPX | QEX | NDX | DJIA |
| Dec. 30, 1988 | 108.13 | 288.07 | 277.72 | 131.93 | 177.41 | 2,169 |
| Dec. 29, 1989 | 135.17 | 379.30 | 353.40 | 164.68 | 223.83 | 2,753 |
| Dec. 31, 1990 | 140.56 | 367.57 | 330.22 | 155.22 | 200.53 | 2,634 |
| Dec. 31, 1991 | 174.85 | 479.51 | 417.09 | 192.78 | 330.85 | 3,169 |
| Dec. 31, 1992 | 195.00 | 516.04 | 435.71 | 198.32 | 360.18 | 3,301 |
| Dec. 31, 1993 | 222.50 | 568.05 | 466.45 | 214.73 | 398.28 | 3,754 |
| Dec. 30, 1994 | 232.50 | 575.55 | 459.27 | 214.32 | 404.27 | 3,834 |
| Dec. 29, 1995 | 281.26 | 791.83 | 615.93 | 292.96 | 576.23 | 5,117 |
| Dec. 31, 1996 | 324.86 | 973.64 | 740.74 | 359.99 | 821.36 | 6,448 |
| Dec. 31, 1997 | 411.41 | 1298.47 | 970.43 | 459.94 | 990.80 | 7,908 |
| Dec. 31, 1998 | 489.37 | 1669.56 | 1229.23 | 604.03 | 1836.01 | 9,181 |
| Dec. 31, 1999 | 592.96 | 2021.41 | 1469.25 | 792.83 | 3707.83 | 11,497 |
| Dec. 29, 2000 | 636.81 | 1837.38 | 1320.28 | 686.45 | 2341.70 | 10,787 |
| Dec. 31, 2001 | 567.25 | 1618.99 | 1148.08 | 584.28 | 1577.05 | 10,022 |

More information on the example index is presented in Whaley, Robert, “Return and Risk of CBOE BuyWrite Monthly Index, Journal of Derivatives, (Winter 2002) pages 35-42; and Moran, Matthew T., “Stablizing Returns With Derivatives—Risk-Adjusted Performance For Derivatives-Based Indexes” Journal of Indexes, (Fourth Quarter 2002) pp. 34-40, the disclosures of which are incorporated herein by this reference.

In another embodiment in accordance with the principles of the present invention, a portfolio of four call options with a constant delta and time to expiration can be used. Delta refers to the amount by which an option's price will change for a one-point change in price by the underlying asset. Indeed, two or more indexes could be formed with different deltas or times to expiration. For example, an index with a delta of 0.5 and the time to expiration 30 calendar days could be formed. The first step is to identify the two nearby calls with adjacent exercise prices and deltas that straddle the underlying asset price level, and the two second nearby calls with adjacent exercise prices and deltas that straddle the underlying asset price level. The portfolio weights for the calls at each maturity are set such that the portfolio has the selected delta of 0.5. Second, the nearby and second nearby option portfolios are weighted in such a way that the weighted average time to maturity is the selected number of 30 days, thereby creating a 30-day at-the-money call. Third, the position should rebalanced at the end of each day.

It should be understood that various changes and modifications preferred in to the embodiment described herein would be apparent to those skilled in the art. Such changes and modifications can be made without departing from the spirit and scope of the present invention and without demising its attendant advantages. It is therefore intended that such changes and modifications be covered by the appended claims.

What is claimed is:

1. A method of creating a financial instrument comprising:
writing a nearby call option against an underlying asset portfolio;
holding the call option; and
writing a new nearby call option against the underlying asset portfolio.

2. The method of making a financial instrument of claim 1 further wherein the call option is cash-settled.

3. The method of making a financial instrument of claim 1 further wherein the call option is held until expiration.

4. The method of making a financial instrument of claim 1 further wherein the premium collected from selling the call is added to the total value of the financial instrument.

5. The method of making a financial instrument of claim 1 wherein the delta is 0.5.

6. The method of making a financial instrument of claim 1 wherein the call option comprises a basket of call options.

7. The method of making a financial instrument of claim 6 wherein the basket of call options comprises call options with different deltas.

8. The method of making a financial instrument of claim 7 wherein the average delta is 0.5.

9. The method of making a financial instrument of claim 1 wherein the call option comprises call options with a constant time to expiration.

10. The method of making a financial instrument of claim 9 wherein the time to expiration is the next available expiration date.

11. The method of making a financial instrument of claim 1 wherein the call option comprises call options with different times to expiration.

12. The method of making a financial instrument of claim 1 wherein any dividends paid on the underlying asset portfolio are invested in more of the underlying asset portfolio.

13. The method of making a financial instrument of claim 1 wherein the call option comprises a security call option.

14. The method of making a financial instrument of claim 12 wherein the call option comprises a stock call option.

15. The method of making a financial instrument of claim 1 wherein the call option comprises a commodity call option.

16. The method of making a financial instrument of claim 1 wherein the call option comprises a stock index call option.

17. The method of making a financial instrument of claim 16 wherein the stock index call option is the Standard & Poor's ® 500 Index.

18. The method of making a financial instrument of claim 1 wherein an underlying asset comprises a stock.

19. The method of making a financial instrument of claim 18 wherein the stock comprises a basket of stocks.

20. The method of making a financial instrument of claim 1 wherein an underlying asset comprises a basket of stocks.

21. The method of making a financial instrument of claim 1 wherein an underlying asset comprises an exchange-traded fund.

22. The method of making a financial instrument of claim 1 wherein an underlying asset comprises an exchange-traded future.

23. The method of making a financial instrument of claim 1 wherein the underlying asset portfolio is selected from the group comprising a security, a derivative and a commodity.

24. The method of making a financial instrument of claim 1 wherein the financial instrument is an index.

25. The method of making a financial instrument of claim 24 wherein the index is updated on a daily basis.

26. The method of making a financial instrument of claim 24 wherein the index is disseminated on a daily basis.

27. The method of making a financial instrument of claim 1 wherein the financial instrument is an exchange-traded fund.

28. A method of making a financial instrument comprising:
identifying nearby calls with adjacent exercise prices and deltas that straddle an underlying asset portfolio price level;
identifying second nearby calls with adjacent exercise prices and deltas that straddle the underlying asset portfolio price level;
writing the calls;
weighing the nearby and second nearby call option portfolios such that the weighted average time to maturity is a selected number of days; and
rebalancing the position.

29. The method of making a financial instrument of claim 28 wherein the portfolio weights for the calls at each maturity are set such that the portfolio has the selected delta.

30. The method of making a financial instrument of claim 29 wherein the selected delta is 0.5.

31. The method of making a financial instrument of claim 28 wherein the selected time to expiration is 30 days.

32. The method of making a financial instrument of claim 28 wherein cash dividends paid on the underlying asset portfolio are invested in more of the underlying asset portfolio.

33. The method of making a financial instrument of claim 28 wherein the call comprises a security call option.

34. The method of making a financial instrument of claim 33 wherein the call comprises a stock call option.

35. The method of making a financial instrument of claim 28 wherein the call comprises a commodity call option.

36. The method of making a financial instrument of claim 28 wherein the call comprises a stock index call option.

37. The method of making a financial instrument of claim 36 wherein the stock index call option is the Standard & Poor's® 500 Index.

38. The method of making a financial instrument of claim 28 wherein an underlying asset comprises a stock.

39. The method of making a financial instrument of claim 38 wherein the stock comprises a basket of stocks.

40. The method of making a financial instrument of claim 28 wherein an underlying asset comprises a basket of stocks.

41. The method of making a financial instrument of claim 28 wherein an underlying asset comprises an exchange-traded fund.

42. The method of making a financial instrument of claim 28 wherein an underlying asset comprises an exchange-traded future.

43. The method of making a financial instrument of claim 28 wherein the underlying asset portfolio is selected from the group comprising a security, a derivative and a commodity.

44. The method of making a financial instrument of claim 28 wherein the financial instrument is an index.

45. The method of making a financial instrument of claim 44 wherein the index is updated on a daily basis.

46. The method of making a financial instrument of claim 44 wherein the index is disseminated on a daily basis.

47. The method of making a financial instrument of claim 28 wherein the financial instrument is an exchange-traded fund.

48. A method of making a financial instrument comprising writing a call option against a same underlying asset portfolio for a set period near the date the previous call option contract expires, the call option having an exercise price just above the prevailing underlying asset portfolio level and having the same set period remaining to expiration as the previous call option contract.

49. The method of making a financial instrument of claim 48 further wherein the call option is written on the date the previous call option contract expires.

50. The method of making a financial instrument of claim 48 further wherein the call option is cash settled.

51. The method of making a financial instrument of claim 48 further wherein the call option is held until expiration.

52. The method of making a financial instrument of claim 48 wherein the call option comprises a security call option.

53. The method of making a financial instrument of claim 52 wherein the call option comprises a stock call option.

54. The method of making a financial instrument of claim 48 wherein the call option comprises a commodity call option.

55. The method of making a financial instrument of claim 48 wherein the call option comprises a stock index call option.

56. The method of making a financial instrument of claim 55 wherein the stock index call option is the Standard & Poor's® 500 Index.

57. The method of making a financial instrument of claim 48 wherein an underlying asset comprises a security.

58. The method of making a financial instrument of claim 57 wherein the security comprises a stock.

59. The method of making a financial instrument of claim 58 wherein the stock comprises a basket of stocks.

60. The method of making a financial instrument of claim 48 wherein an underlying asset comprises a basket of stocks.

61. The method of making a financial instrument of claim 48 wherein an underlying asset comprises an exchange traded fund.

62. The method of making a financial instrument of claim 48 wherein an underlying asset comprises an exchange-traded future.

63. The method of making a financial instrument of claim 48 wherein the underlying asset portfolio is selected from the group comprising a security, a derivative and a commodity.

64. The method of making a financial instrument of claim 48 wherein the financial instrument is an index.

65. The method of making a financial instrument of claim 64 wherein the index is updated on a daily basis.

66. The method of making a financial instrument of claim 64 wherein the index is disseminated on a daily basis.

67. The method of making a financial instrument of claim 48 wherein the financial instrument is an exchange-traded fund.

68. A financial instrument comprising a passive total return based on writing the nearby call option against that same underlying asset portfolio for a set period near the day the previous nearby call option contract expires.

69. The financial instrument of claim 68 further wherein the nearby call option is written on the date the previous call option contract expires.

70. The financial instrument of claim 68 further wherein the call written has the same set period remaining to expiration.

71. The financial instrument of claim 68 further wherein the call written has an exercise price just above the prevailing underlying asset portfolio price level.

72. The financial instrument of claim 68 further wherein the call is held until expiration and cash settled, at which time a new call option is written for the set period.

73. The financial instrument of claim 68 wherein the call option comprises a security call option.

74. The financial instrument of claim 73 wherein the call option comprises a stock call option.

75. The financial instrument of claim 68 wherein the call option comprises a commodity call option.

76. The financial instrument of claim 68 wherein the call option comprises a stock index call option.

77. The financial instrument of claim 76 wherein the stock index call option is the Standard & Poor's® 500 Index.

78. The financial instrument of claim 68 wherein an underlying asset comprises a stock.

79. The financial instrument of claim 78 wherein the stock comprises a basket of stocks.

80. The financial instrument of claim 68 wherein an underlying asset comprises a basket of stocks.

81. The financial instrument of claim 68 wherein an underlying asset comprises an exchange traded fund.

82. The financial instrument of claim 68 wherein an underlying asset comprises an exchange-traded future.

83. The financial instrument of claim 68 wherein the underlying asset portfolio is selected from the group comprising a security, a derivative and a commodity.

84. The financial instrument of claim 68 wherein the financial instrument is an index.

85. The financial instrument of claim 84 wherein the index is updated on a daily basis.

86. The financial instrument of claim 84 wherein the index is disseminated on a daily basis.

87. The financial instrument of claim 68 wherein the financial instrument is an exchange traded fund.

88. A method of making a financial instrument comprising:
buying a put option against an underlying asset portfolio;
holding the put option;
investing any dividends paid on the underlying asset portfolio in more of the underlying asset portfolio; and
buying a new put option against the underlying asset portfolio.

89. The method of making a financial instrument of claim 88 further wherein the put option is held until expiration.

90. The method of making a financial instrument of claim 88 wherein the put option comprises a basket of put options.

91. The method of making a financial instrument of claim 90 wherein the basket of put options comprises put options with different deltas.

92. The method of making a financial instrument of claim 91 wherein the average delta is 0.5.

93. The method of making a financial instrument of claim 88 wherein the put option comprises put options with a constant time to expiration.

94. The method of making a financial instrument of claim 93 wherein the time to expiration is the next available expiration date.

95. The method of making a financial instrument of claim 88 herein the put option comprises put options with different times to expiration.

96. The method of making a financial instrument of claim 88 wherein the put option comprises a security put option.

97. The method of making a financial instrument of claim 96 wherein the security put option comprises a stock put option.

98. The method of making a financial instrument of claim 88 herein the put option comprises a commodity put option.

99. The method of making a financial instrument of claim 88 wherein the put option comprises a stock index put option.

100. The method of making a financial instrument of claim 99 wherein the stock index put option is the Standard & Poor's® 500 Index.

101. The method of making a financial instrument of claim 88 wherein the asset comprises a security.

102. The method of making a financial instrument of claim 101 wherein the security comprises a stock.

103. The method of making a financial instrument of claim 102 wherein the stock comprises a basket of stocks.

104. The method of making a financial instrument of claim 88 wherein the asset comprises a basket of stocks.

105. The method of making a financial instrument of claim 88 wherein the asset comprises an exchange-traded fund.

106. The method of making a financial instrument of claim 88 wherein the asset comprises an exchange-traded future.

107. The method of making a financial instrument of claim 88 wherein the asset portfolio is selected from the group comprising a security, a derivative and a commodity.

108. The method of making a financial instrument of claim 88 wherein the financial instrument is an index.

109. The method of making a financial instrument of claim 108 wherein the index is updated on a daily basis.

110. The method of making a financial instrument of claim 108 wherein the index is disseminated on a daily basis.

111. The method of making a financial instrument of claim 88 wherein the financial instrument is an exchange-traded fund.

112. A financial instrument comprising:
buying a put option and writing a call option against an underlying asset portfolio;
holding the put option and call option;
investing any dividends paid on the underlying asset portfolio in more of the underlying asset portfolio; and
buying a new put option and selling a call option against the underlying asset portfolio.

113. The method of making a financial instrument of claim 1 further wherein the options are held until expiration.

114. The method of making a financial instrument of claim 112 wherein the options comprises a basket of options.

115. The method of making a financial instrument of claim 114 wherein the basket of options comprises options with different deltas.

116. The method of making a financial instrument of claim 115 wherein the average delta is 0.5.

117. The method of making a financial instrument of claim 112 wherein the option comprises options with a constant time to expiration.

118. The method of making a financial instrument of claim 117 wherein the time to expiration is the next available expiration date.

119. The method of making a financial instrument of claim 112 wherein the option comprises options with different times to expiration.

120. The method of making a financial instrument of claim 112 wherein the option comprises a security option.

121. The method of making a financial instrument of claim 120 wherein the security option comprises a stock option.

122. The method of making a financial instrument of claim 112 wherein the option comprises a commodity option.

123. The method of making a financial instrument of claim 112 wherein the option comprises a stock index option.

124. The method of making a financial instrument of claim 123 wherein the stock index option is the Standard & Poor's® 500 Index.

125. The method of making a financial instrument of claim 112 wherein an underlying asset comprises a security.

126. The method of making a financial instrument of claim 125 wherein the security comprises a stock.

127. The method of making a financial instrument of claim 126 wherein the stock comprises a basket of stocks.

128. The method of making a financial instrument of claim 112 wherein an underlying asset comprises a basket of stocks.

129. The method of making a financial instrument of claim 112 wherein an underlying asset comprises an exchange-traded fund.

130. The method of making a financial instrument of claim 112 wherein an underlying asset comprises an exchange-traded future.

131. The method of making a financial instrument of claim 112 wherein an underlying asset portfolio is selected from the group comprising a security, a derivative and a commodity.

132. The method of making a financial instrument of claim 112 wherein the financial instrument is an index.

133. The method of making a financial instrument of claim 132 wherein the index is updated on a daily basis.

134. The method of making a financial instrument of claim 132 wherein the index is disseminated on a daily basis.

135. The method of making a financial instrument of claim 112 wherein the financial instrument is an exchange-traded fund.
